(19) United States
(12) Patent Application Publication
(10) Pub. No.: US 2009/0027215 A1
(43) Pub. Date: Jan. 29, 2009

(54) Guardian angel Christmas tree topper

(76) Inventor: Darrell Hudson, Orange Park, FL (US)

Correspondence Address: JAMES RAY & ASSOCIATES, 2640 PITCAIRN ROAD, MONROEVILLE, PA, 15146, US

(21) Appl. No.: 11/881,548

(22) Filed: Jul. 27, 2007

(51) Int. Cl. G08B 17/10

(52) U.S. Cl. 340/628

(57) ABSTRACT

A Christmas tree topper includes a housing manufactured from a predetermined material and having a predetermined size and a predetermined shape adapted for use on a Christmas tree as a Christmas tree-top ornament. The tree topper has an interior space adjacent a bottom thereof. A detector mechanism is disposed within the interior space of such housing for providing a signal upon detection of at least one of a predetermined amount of smoke and heat. An audible alarm device is operably connected to the detector and disposed within such housing for both receiving the signal provided by the detector and for emitting an audible alarm upon detection of such at least one of the predetermined amount of smoke and heat. There is a control apparatus operably connected to the detector and disposed one of within and on such housing for turning such detector on and off.

### FIELD OF THE INVENTION

The present invention relates, in general, to smoke detectors and, more particularly, this invention relates to a combination Christmas tree topper and smoke and fire detector.

### BACKGROUND OF THE INVENTION

Prior to the conception and development of the present invention, smoke detectors, as are generally well known in the prior art, have been used primarily in buildings as a means to detect and alert homeowners of fires within the home. During the Christmas season there exists a more prevalent need for smoke and fire detection systems due to the increased risk of fires associated with Christmas trees.

Specifically of interest to the present invention are the following: Smythe, et al, U.S. Design Pat. No. 405,707 discloses the ornamental design for a combined Christmas tree angel ornament and smoke alarm. Welter, et al, U.S. Design Pat. No. 404,669 also discloses the ornamental design for a Christmas tree top smoke alarm. Schoenwetter, U.S. Pat. No. 4,623,878 discloses a smoke alarm mounted atop a Christmas tree. Tsou, U.S. Pat. No. 5,880,676 discloses a spherical Christmas tree ornament containing a fire alarm which can be hung by a hook on a Christmas tree.

### SUMMARY OF THE INVENTION

The present invention provides a Christmas tree topper. This Christmas tree topper comprises a housing manufactured from a predetermined material and having a predetermined size and a predetermined shape adapted for use on a Christmas tree as a Christmas tree-top ornament. The housing has an interior space adjacent a bottom thereof for receiving therein a detector means for providing a signal upon detection of at least one of a predetermined amount of smoke and heat. An audible alarm means is operably connected to the detector means and disposed within such housing for both receiving the signal provided by the detector and for emitting an audible alarm upon detection of the at least one of such predetermined amount of smoke and heat. A control means is operably connected to the detector means and is disposed one of within and on the housing for turning such detector means on and off.

### OBJECTS OF THE INVENTION

It is, therefore, one of the primary objects of the present invention to provide a combination smoke and fire detector and Christmas tree-top ornament.

Another object of the present invention is to provide a smoke and fire detection device which will serve to warn users of a fire and smoke within a user's home or building and therefore allow the user to evacuate the home or building and extinguish a fire in time to save lives and property.

Still another object of the present invention is to provide a decorative Christmas tree-top ornament in a variety of colors, sizes, shapes, and characters which will be attractive tog numerous consumers and which will be useful as well as decorative.

Yet another object of the present invention is to provide a means for consumers to add an additional safeguard against the dangers of a Christmas tree fire.

An additional object of the present invention is to provide an alarm specifically designed to detect Christmas tree fires earlier and therefore warn users earlier than standard smokes detectors within a home or building.

In addition to the various objects and advantages of the present invention described with some degree of specificity above it should be obvious that additional objects and advantages of the present invention will become more readily apparent to those persons who are skilled in the relevant art from the following more detailed description of the invention, particularly, when such description is taken in conjunction with the attached drawing figures and with the appended claims.

### BRIEF DESCRIPTION OF THE DRAWINGS

FIG. 1 is a partial perspective view of the Christmas tree topper according to one embodiment of the present invention.

FIG. 2 is a partial perspective view of the Christmas tree topper according to one embodiment of the present invention.

FIG. 3 is a partial perspective view of the Christmas tree topper according to one embodiment of the present invention.

FIG. 4 is a partial perspective view of the Christmas tree topper according to one embodiment of the present invention.

FIG. 5 is a partial perspective view of the Christmas tree topper according to one embodiment of the present invention.

FIG. 6 is a partial perspective view of the Christmas tree topper according to one embodiment of the present invention.

FIG. 7 is a partial schematic view of the Christmas tree topper according to one embodiment of the present invention.

### BRIEF DESCRIPTION OF A PRESENTLY PREFERRED AND VARIOUS ALTERNATIVE EMBODIMENTS OF THE INVENTION

Prior to proceeding to the more detailed description of the present invention it should be noted that, for the sake of clarity and understanding, identical components which have identical functions have been identified with identical reference numerals throughout the several views illustrated in the drawing figures.

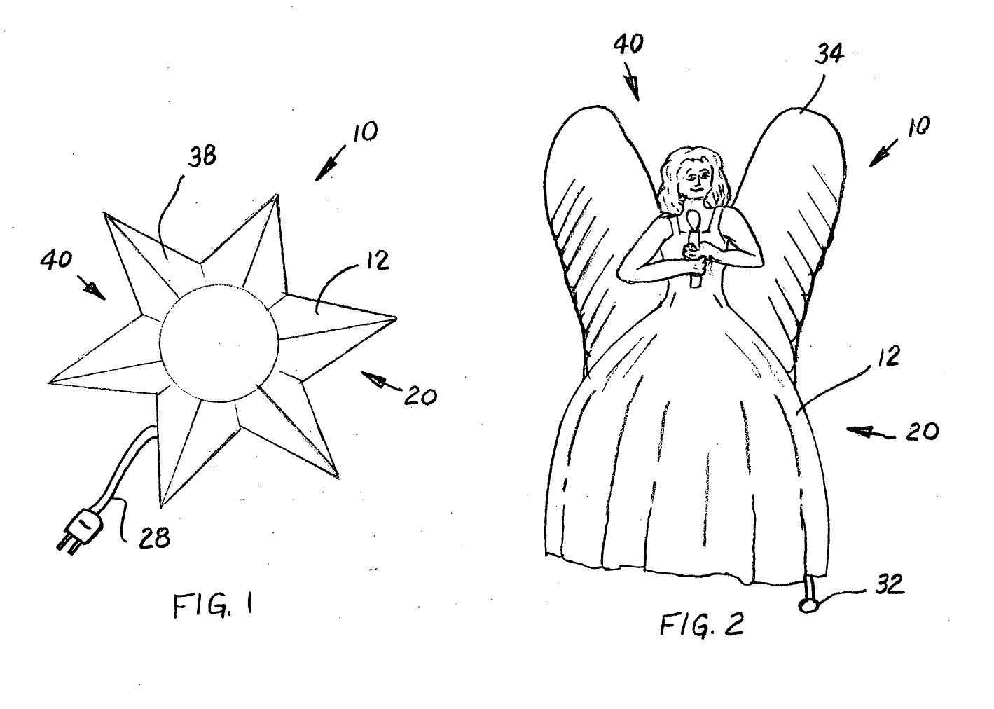

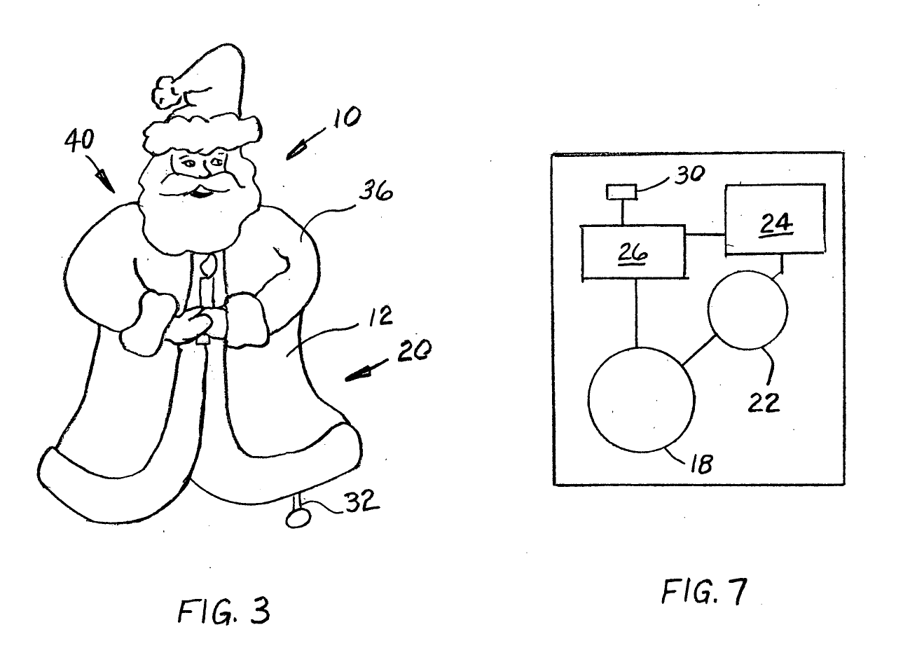

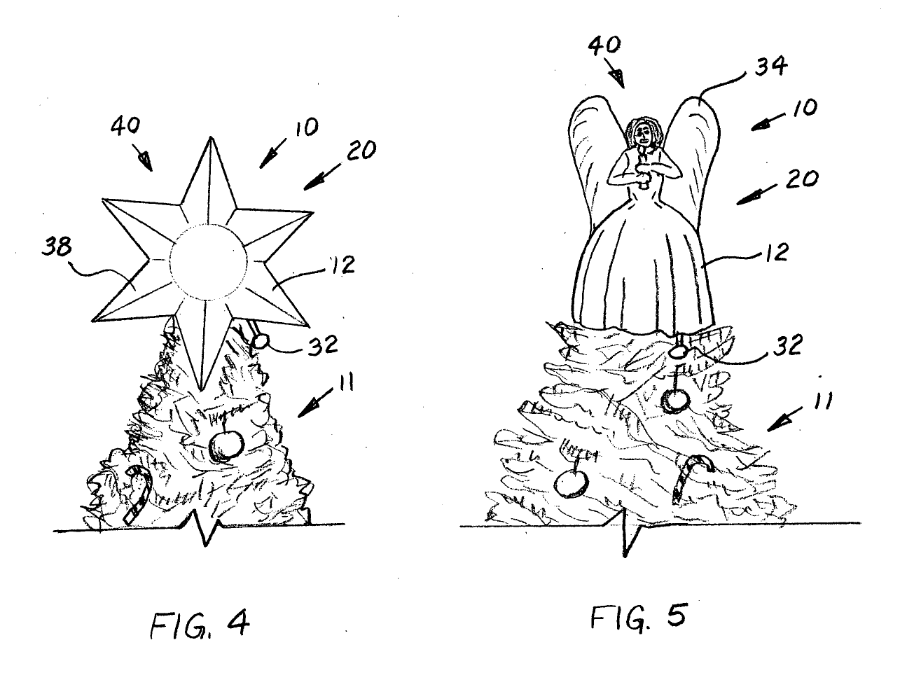

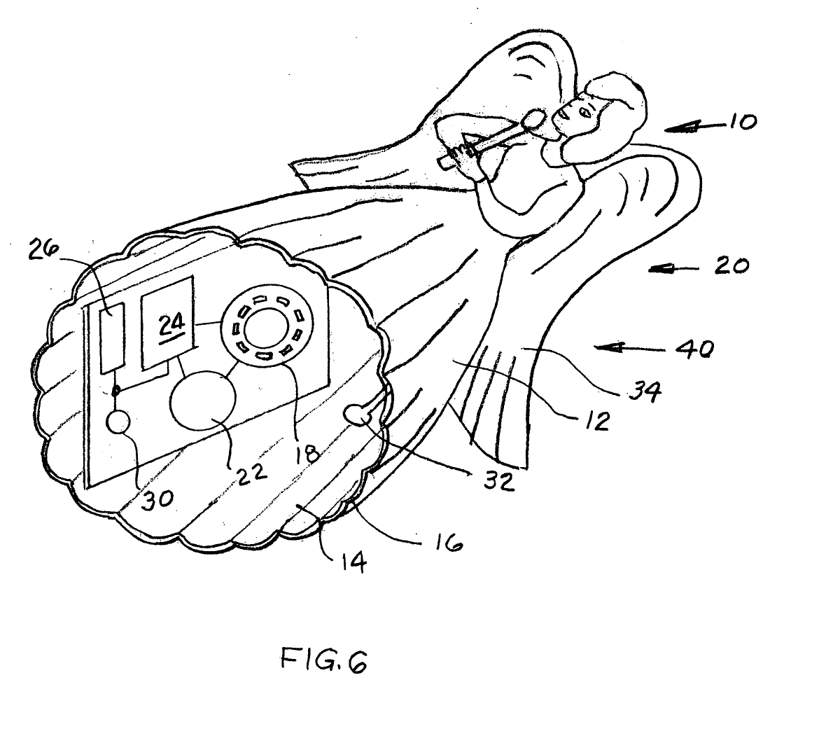

Reference is now made, more particularly, to FIGS. 1-7. According to a first embodiment of the invention, illustrated in FIGS. 1-7 is a Christmas tree topper, generally designated 10. The Christmas tree topper 10 includes a housing member 12 manufactured from a predetermined material. In the presently preferred embodiment of the invention, predetermined material will be selected from the group consisting of metal, plastic and fabric. Preferably, such predetermined material is plastic.

The housing member 12 has a predetermined size and a predetermined shape adapted for use on a Christmas tree, generally designated 11, as a Christmas tree-top ornament, generally designated 20. Such Christmas tree-top ornament 20 has an interior space 14 adjacent a bottom 16 thereof.

A detector means 18 is disposed within such interior space 14 of such housing member 12 for providing a signal upon detection of at least one of a predetermined amount of smoke and heat.

An audible alarm means 22 is operably connected to the detector means 18 and disposed within such housing member 12 for both receiving such signal provided by the detector means 18 and for emitting an audible alarm upon the detection of at least one of a predetermined amount of smoke and heat.

A control means 24 operably connected to the detector means 18 and disposed one of within and on such housing member 12 for turning the detector means 18 on and off. In the presently preferred embodiment of the present invention, the power source for the detection means is at least one of at least one battery 26 and electric power 28.

In the presently preferred embodiment of the present invention, the at least one battery 26 is operably connected to a low battery detection means 30 for indicating that such at least one battery 26 within the housing member 12 is providing power below a predetermined level.

In the presently preferred embodiment of the present invention, such low battery detection means 30 is operably connected to a lighting means 32 disposed at a predetermined location of such housing member 12 for indicating when such at least one battery 26 is low.

In the presently preferred embodiment of the present invention, the Christmas tree-top ornament 20 includes a decorative covering, generally designated 40. According to yet another embodiment of the present invention, such decorative covering 40 is formed as an angel 34.

According to yet another embodiment of the present invention, such decorative covering 40 is formed as a Santa Claus 36.

According to yet another embodiment of the present invention, such decorative covering 40 is formed as a star 38.

While a presently preferred and various alternative embodiments of the present invention have been described in sufficient detail above to enable a person skilled in the relevant art to make and use the same it should be obvious that various other adaptations and modifications can be envisioned by those persons skilled in such art without departing from either the spirit of the invention or the scope of the appended claims.

I claim:

1. A Christmas tree topper, said Christmas tree topper comprising:
a. a housing manufactured from a predetermined material and having a predetermined size and a predetermined shape adapted for use on a Christmas tree (not shown)as a Christmas tree-top ornament and having an interior space adjacent a bottom thereof;
b. a detector means disposed within said interior space of said housing for providing a signal upon detection of at least one of a predetermined amount of smoke and heat;
c. an audible alarm means operably connected to said detector means and disposed within said housing for both receiving said signal provided by said detector means and for emitting an audible alarm upon said detection of said at least one of said predetermined amount of smoke and heat; and
d. a control means operably connected to said detector means and disposed one of within and on said housing for turning said detector means on and off.

2. A Christmas tree topper of claim 1 wherein said power source for said detection means is at least one of at least one battery and electric power.

3. A Christmas tree topper of claim 1 wherein said at least one battery is operably connected to a low battery detection means for indicating that said at least one battery within said housing is providing power below a predetermined level.

4. A Christmas tree topper of claim 4 wherein said low battery detection means is operably connected to a lighting means disposed at a predetermined location of said housing for indicating when said battery is low.

5. A Christmas tree topper, according to claim 1, wherein said ornament includes a decorative covering.

6. A Christmas tree topper of claim 1 wherein said decorative covering is formed as an angel.

7. A Christmas tree topper of claim 1 wherein said decorative covering is formed as a Santa Claus.

8. A Christmas tree topper of claim 1 wherein said decorative covering is formed as a star.

9. A Christmas tree topper of claim 1 wherein said predetermined material is selected from the group consisting of metal, plastic and fabric.

10. A Christmas tree topper of claim 9 wherein said predetermined material is plastic.
